(19) United States
(12) Patent Application Publication
(10) Pub. No.: US 2014/0003504 A1
(43) Pub. Date: Jan. 2, 2014

(54) Apparatus, a Method and a Computer Program for Video Coding and Decoding

(71) Applicants: Kemal UGUR, Istanbul (TR); Jani LAINEMA, Tampere (FI); Miska Matias HANNUKSELA, Tampere (FI)

(72) Inventors: Kemal UGUR, Istanbul (TR); Jani LAINEMA, Tampere (FI); Miska Matias HANNUKSELA, Tampere (FI)

(73) Assignee: NOKIA CORPORATION, Espoo (FI)

(21) Appl. No.: 13/924,981

(22) Filed: Jun. 24, 2013

Related U.S. Application Data
(60) Provisional application No. 61/667,368, filed on Jul. 2, 2012.

(51) Int. Cl. H04N 7/46

(52) U.S. Cl. CPC H04N 19/00757
USPC 375/240.12; 375/240.21

(57) ABSTRACT

There is provided a method, apparatus and computer program product for scalable video encoding and decoding. In some embodiments, an improved method of encoding/decoding of enhancement layer pictures is introduced to enable encoding an area within an enhancement layer picture with increased quality and/or spatial resolution and with high coding efficiency. Enhancement layer sub-pictures have a size smaller than the corresponding enhancement layer pictures. They are coded with respect to the previously coded base-layer pictures or enhancement layer pictures. The enhancement information could be in the form of: increasing the fidelity of the chroma; increasing the bit-depth; increasing the quality of a region; or increasing the spatial resolution of a region.

### TECHNICAL FIELD

The present invention relates to an apparatus, a method and a computer program for video coding and decoding.

### BACKGROUND INFORMATION

A video codec may comprise an encoder which transforms input video into a compressed representation suitable for storage and/or transmission and a decoder that can uncompress the compressed video representation back into a viewable form, or either one of them. Typically, the encoder discards some information in the original video sequence in order to represent the video in a more compact form, for example at a lower bit rate.

Scalable video coding refers to coding structure where one bitstream can contain multiple representations of the content at different bitrates, resolutions or frame rates. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers.

A scalable video codec for quality scalability (also known as Signal-to-Noise or SNR) and/or spatial scalability may be implemented as follows. For a base layer, a conventional non-scalable video encoder and decoder are used. The reconstructed/decoded pictures of the base layer are included in the reference picture buffer for an enhancement layer. In codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use typically with a reference picture index in the coded bitstream. The decoder decodes from the bitstream, for example from a reference picture index, that a base-layer picture is used as inter prediction reference for the enhancement layer.

In addition to quality scalability, scalability can be achieved through spatial scalability, where base layer pictures are coded at a higher resolution than enhancement layer pictures, bit-depth scalability, where base layer pictures are coded at lower bit-depth (e.g. 8 bits) than enhancement layer pictures (e.g. 10 or 12 bits), and chroma format scalability, where base layer pictures provide higher fidelity in chroma (e.g. coded in 4:4:4 chroma format) than enhancement layer pictures (e.g. 4:2:0 format).

In certain cases, it would be desirable to enhance only an area within the picture instead of an entire enhancement layer picture. However, if implemented in current scalable video coding solutions, such scalability would either have too much complexity overhead or suffer from coding efficiency. For example, considering bit-depth scalability, where only an area within the video picture is targeted to be coded at higher bit-depth, current scalable coding solutions nevertheless require the entire picture to be coded at high bit-depth, thus drastically increasing the complexity. For the case of chroma format scalability, the reference memory of the entire picture should be in 4:4:4 format, even if only a certain region of the image is enhanced, thus increasing the memory requirement. Similarly, if spatial scalability is to be applied only for a selected region, traditional methods require storing and maintaining the whole enhancement layer image in full resolution.

### SUMMARY

This invention proceeds from the consideration that in order to enable encoding an area within an enhancement layer picture with increased quality and/or spatial resolution and with high coding efficiency, a new concept of enhancement layer sub-picture is introduced.

A method according to a first embodiment comprises a method for encoding one or more enhancement layer sub-pictures for a given base-layer picture, said one or more enhancement layer sub-pictures having a size smaller than the corresponding enhancement layer reconstructed picture, the method comprising
encoding and reconstructing said base-layer picture;
encoding and reconstructing said one or more enhancement layer sub-pictures;
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to an embodiment, the method further comprises encoding predictively said one or more enhancement layer sub-pictures with respect to the base-layer picture.

According to an embodiment, the enhancement layer sub-pictures are allowed to be predictively coded with respect to earlier coded enhancement layer pictures.

According to an embodiment, the enhancement layer sub-pictures are allowed to be predictively coded with respect to earlier coded enhancement layer sub-pictures.

According to an embodiment, the enhancement layer sub-pictures contain enhancement information to the corresponding base layer picture, the enhancement information including at least one of the following:
increasing the fidelity of the chroma of said one or more enhancement layer sub-pictures with respect to the chroma of the corresponding base layer picture;
increasing the bit-depth of said one or more enhancement layer sub-pictures with respect to the bit-depth of the corresponding base layer picture;
increasing the quality of said one or more enhancement layer sub-pictures with respect to the quality of the corresponding base layer picture; or
increasing the spatial resolution of said one or more enhancement layer sub-pictures with respect to the spatial resolution of the corresponding base layer picture.

According to an embodiment, the enhancement layer information for sub-picture is coded with the same syntax as it would be coded for an enhancement layer picture.

According to an embodiment, the upper-left corner of the enhancement layer sub-picture may be aligned to the upper-left corner of a largest coding unit (LCU) of the picture.

According to an embodiment, the size of the enhancement layer sub-picture may be restricted to integer multiples (1, 2, 3, 4, . . . ) of the size of the largest coding unit (LCU) or the size of the prediction unit (PU) or the size of the coding unit (CU).

According to an embodiment, if the enhancement layer sub-picture is coded predictively with respect to base layer, the prediction process may be restricted so that only the pixels within the co-located area of base layer picture could be used.

According to an embodiment, the number of enhancement layer sub-pictures could change for different pictures or stay fixed.

According to an embodiment, if the enhancement layer sub-picture is coded predictively with respect to base layer, the prediction process may involve different image processing operations.

According to an embodiment, a first enhancement layer sub-picture may enhance different characteristics of the image than a second enhancement layer sub-picture.

According to an embodiment, single enhancement layer sub-picture may enhance multiple characteristics of the image.

According to an embodiment, the size and location of the enhancement layer sub-pictures may change for different pictures or stay fixed.

According to an embodiment, the position and size of the enhancement layer sub-pictures may be the same as tiles or slices used in the base layer picture.

According to an embodiment, the size and position of enhancement layer sub-pictures may be restricted so they are spatially non-overlapping.

According to an embodiment, the size and position of enhancement layer sub-pictures may be allowed to be spatially overlapping.

According to an embodiment, the enhancement layer sub-picture concept could be implemented in the form of Supplemental Enhancement Information (SEI) message.

According to an embodiment, the one or more enhancement layer sub-pictures is converted to the same format used in the samples outside the area of said reconstructed one or more enhancement layer sub-pictures copied from the reconstructed base layer picture to the reconstructed enhancement layer picture, and the converted enhancement-layer picture are merged to form a single enhancement layer picture in a reference frame buffer.

An apparatus according to a second embodiment comprises:
a video encoder configured for encoding a scalable bitstream comprising a base layer and at least one enhancement layer, wherein said video encoder is further configured for
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture;
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to a third embodiment there is provided a computer readable storage medium stored with code thereon for use by an apparatus, which when executed by a processor, causes the apparatus to perform:
encoding a scalable bitstream comprising a base layer and at least one enhancement layer;
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture; and
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to a fourth embodiment there is provided at least one processor and at least one memory, said at least one memory stored with code thereon, which when executed by said at least one processor, causes an apparatus to perform:
encoding a scalable bitstream comprising a base layer and at least one enhancement layer;
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture; and
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

A method according to a fifth embodiment comprises a method for decoding a scalable bitstream comprising a base layer and at least one enhancement layer, the method comprising
decoding a base-layer picture;
decoding one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to an embodiment, decoded enhancement layer sub-pictures are placed in reference frame buffer separately than the decoded enhancement layer pictures.

According to an embodiment, decoded enhancement layer pictures are not placed in reference frame buffer, but decoded enhancement layer sub-pictures are placed in the reference frame buffer.

According to an embodiment, if spatial scalability is used, then samples outside the enhancement layer sub-picture area are copied from an upsampled base-layer picture.

According to an embodiment, decoding said one or more enhancement layer sub-pictures utilizes information from the base layer.

According to an embodiment, the one or more enhancement layer sub-pictures is converted to the same format used in the samples outside the area of said decoded one or more enhancement layer sub-pictures copied from the decoded base layer picture to the reconstructed enhancement layer picture, and the converted enhancement layer picture is merged to form a single enhancement layer picture in a reference frame buffer.

An apparatus according to a sixth embodiment comprises:
a video decoder configured for decoding a scalable bitstream comprising a base layer and at least one enhancement layer, the video decoder being configured for
decoding a base-layer picture;
decoding one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to a seventh embodiment there is provided a computer readable storage medium stored with code thereon for use by an apparatus, which when executed by a processor, causes the apparatus to perform:
decoding a scalable bitstream comprising a base layer and at least one enhancement layer, the video decoder being configured for
decoding a base-layer picture;
decoding one or more enhancement layer sub-pictures for a given base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to an eighth embodiment there is provided at least one processor and at least one memory, said at least one memory stored with code thereon, which when executed by said at least one processor, causes an apparatus to perform:
decoding a scalable bitstream comprising a base layer and at least one enhancement layer, the video decoder being configured for
decoding a base-layer picture;
decoding one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to a ninth embodiment there is provided a video encoder configured for encoding a scalable bitstream comprising a base layer and at least one enhancement layer, wherein said video encoder is further configured for
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture; and
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to a tenth embodiment there is provided a video decoder configured for decoding a scalable bitstream comprising a base layer and at least one enhancement layer, the video decoder being configured for
decoding a base-layer picture;
decoding one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

### DESCRIPTION OF THE DRAWINGS

For better understanding of the present invention, reference will now be made by way of example to the accompanying drawings in which:

FIG. 1 shows schematically an electronic device employing some embodiments of the invention;

FIG. 2 shows schematically a user equipment suitable for employing some embodiments of the invention;

FIG. 3 further shows schematically electronic devices employing embodiments of the invention connected using wireless and wired network connections;

FIG. 4 shows schematically an encoder suitable for implementing some embodiments of the invention;

FIG. 5 shows the concept of an enhancement layer sub-picture according an embodiment of the invention;

FIG. 6 shows the concept of an enhancement layer sub-picture according another embodiment of the invention;

FIG. 7 shows an embodiment for restricting referencing from a base-layer picture to an enhancement layer sub-picture;

FIG. 8 shows examples of applying an enhancement layer sub-picture to 3d and multiview video encoding according to some embodiments of the invention; and

FIG. 9 shows a schematic diagram of a decoder according to some embodiments of the invention.

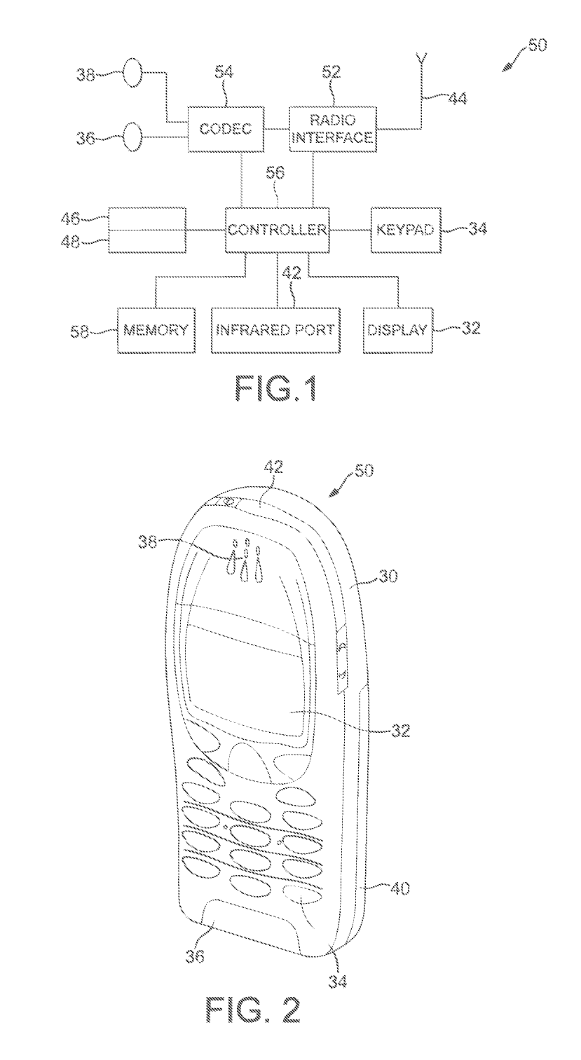

### DETAILED DESCRIPTION OF SOME EXAMPLE EMBODIMENTS OF THE INVENTION

The following describes in further detail suitable apparatus and possible mechanisms for encoding an enhancement layer sub-picture without significantly sacrificing the coding efficiency. In this regard reference is first made to FIG. 1 which shows a schematic block diagram of an exemplary apparatus or electronic device 50, which may incorporate a codec according to an embodiment of the invention.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In other embodiments of the invention, the apparatus may receive the video image data for processing from another device prior to transmission and/or storage. In other embodiments of the invention, the apparatus 50 may receive either wirelessly or by a wired connection the image for coding/decoding.

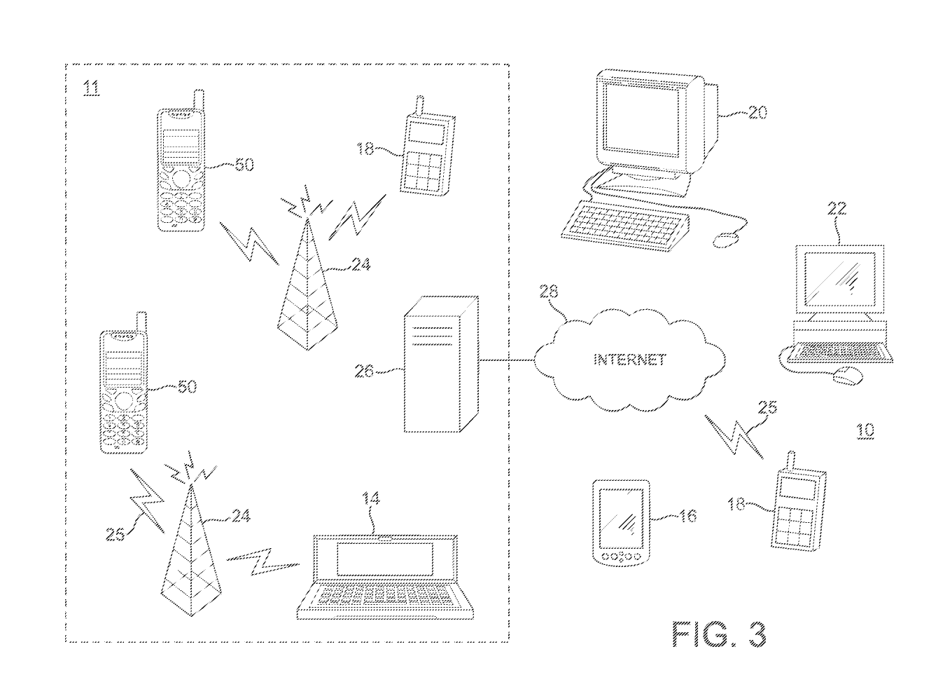

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Video codec consists of an encoder that transforms the input video into a compressed representation suited for storage/transmission and a decoder that can uncompress the compressed video representation back into a viewable form. Typically encoder discards some information in the original video sequence in order to represent the video in a more compact form (that is, at lower bitrate).

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Video coding is typically a two-stage process: First, a prediction of the video signal is generated based on previous coded data. Second, the residual between the predicted signal and the source signal is coded. Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

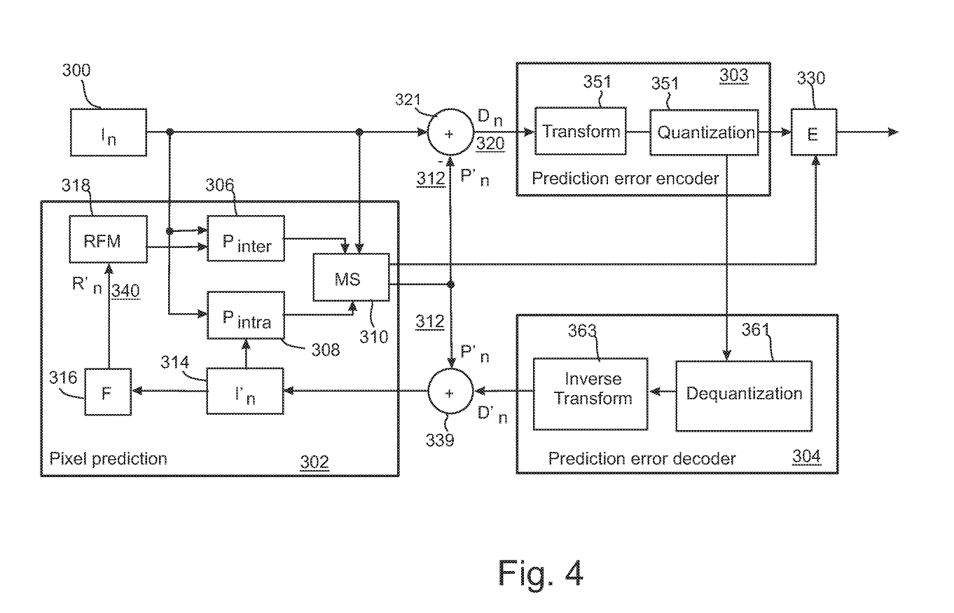

With respect to FIG. 4, a block diagram of a video encoder suitable for carrying out embodiments of the invention is shown. FIG. 4 shows the encoder as comprising a pixel predictor 302, prediction error encoder 303 and prediction error decoder 304. FIG. 4 also shows an embodiment of the pixel predictor 302 as comprising an inter-predictor 306, an intra-predictor 308, a mode selector 310, a filter 316, and a reference frame memory 318. The pixel predictor 302 receives the image 300 to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the image 300.

Depending on which encoding mode is selected to encode the current block, the output of the inter-predictor 306 or the output of one of the optional intra-predictor modes or the output of a surface encoder within the mode selector is passed to the output of the mode selector 310. The output of the mode selector is passed to a first summing device 321. The first summing device may subtract the output of the pixel predictor 302 from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which a future image 300 is compared in inter-prediction operations.

The operation of the pixel predictor 302 may be configured to carry out any known pixel prediction algorithm known in the art.

The prediction error encoder 303 comprises a transform unit 342 and a quantizer 344. The transform unit 342 transforms the first prediction error signal 320 to a transform domain. The transform is, for example, the DCT transform. The quantizer 344 quantizes the transform domain signal, e.g. the DCT coefficients, to form quantized coefficients.

The prediction error decoder 304 receives the output from the prediction error encoder 303 and performs the opposite processes of the prediction error encoder 303 to produce a decoded prediction error signal 338 which, when combined with the prediction representation of the image block 312 at the second summing device 339, produces the preliminary reconstructed image 314. The prediction error decoder may be considered to comprise a dequantizer 361, which dequantizes the quantized coefficient values, e.g. DCT coefficients, to reconstruct the transform signal and an inverse transformation unit 363, which performs the inverse transformation to the reconstructed transform signal wherein the output of the inverse transformation unit 363 contains reconstructed block(s). The prediction error decoder may also comprise a macroblock filter which may filter the reconstructed macroblock according to further decoded information and filter parameters.

The entropy encoder 330 receives the output of the prediction error encoder 303 and may perform a suitable entropy encoding/variable length encoding on the signal to provide error detection and correction capability.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC). There is a currently ongoing standardization project of High Efficiency Video Coding (HEVC) by the Joint Collaborative Team—Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in a draft HEVC standard—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

In the description of existing standards as well as in the description of example embodiments, a syntax element may be defined as an element of data represented in the bitstream. A syntax structure may be defined as zero or more syntax elements present together in the bitstream in a specified order.

A profile may be defined as a subset of the entire bitstream syntax that is specified by a decoding/coding standard or specification. Within the bounds imposed by the syntax of a given profile it is still possible to require a very large variation in the performance of encoders and decoders depending upon the values taken by syntax elements in the bitstream such as the specified size of the decoded pictures. In many applications, it might be neither practical nor economic to implement a decoder capable of dealing with all hypothetical uses of the syntax within a particular profile. In order to deal with this issue, levels may be used. A level may be defined as a specified set of constraints imposed on values of the syntax elements in the bitstream and variables specified in a decoding/coding standard or specification. These constraints may be simple limits on values. Alternatively or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles.

The elementary unit for the input to an H.264/AVC or HEVC encoder and the output of an H.264/AVC or HEVC decoder, respectively, is a picture. In H.264/AVC and HEVC, a picture may either be a frame or a field. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

In H.264/AVC, a macroblock is a 16×16 block of luma samples and the corresponding blocks of chroma samples. For example, in the 4:2:0 sampling pattern, a macroblock contains one 8×8 block of chroma samples per each chroma component. In H.264/AVC, a picture is partitioned to one or more slice groups, and a slice group contains one or more slices. In H.264/AVC, a slice consists of an integer number of macroblocks ordered consecutively in the raster scan within a particular slice group.

In some video codecs, such as High Efficiency Video Coding (HEVC) codec, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size is typically named as LCU (largest coding unit) and the video picture is divided into non-overlapping LCUs. An LCU can be further split into a combination of smaller CUs, e.g. by recursively splitting the LCU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the said TU (including e.g. DCT coefficient information). It is typically signalled at CU level whether prediction error coding is applied or not for each CU. In the case there is no prediction error residual associated with the CU, it can be considered there are no TUs for the said CU. The division of the image into CUs, and division of CUs into PUs and TUs is typically signalled in the bitstream allowing the decoder to reproduce the intended structure of these units.

In a draft HEVC standard, a picture can be partitioned in tiles, which are rectangular and contain an integer number of LCUs. In a draft HEVC standard, the partitioning to tiles forms a regular grid, where heights and widths of tiles differ from each other by one LCU at the maximum. In a draft HEVC, a slice consists of an integer number of CUs. The CUs are scanned in the raster scan order of LCUs within tiles or within a picture, if tiles are not in use. Within an LCU, the CUs have a specific scan order.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

C=D+λR, (1)

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to coded slices or alike. In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring macroblock or CU may be regarded as unavailable for intra prediction, if the neighboring macroblock or CU resides in a different slice.

Coded slices can be categorized into three classes: raster-scan-order slices, rectangular slices, and flexible slices.

A raster-scan-order-slice is a coded segment that consists of consecutive macroblocks or alike in raster scan order. For example, video packets of MPEG-4 Part 2 and groups of macroblocks (GOBs) starting with a non-empty GOB header in H.263 are examples of raster-scan-order slices.

A rectangular slice is a coded segment that consists of a rectangular area of macroblocks or alike. A rectangular slice may be higher than one macroblock or alike row and narrower than the entire picture width. H.263 includes an optional rectangular slice submode, and H.261 GOBs can also be considered as rectangular slices.

A flexible slice can contain any pre-defined macroblock (or alike) locations. The H.264/AVC codec allows grouping of macroblocks to more than one slice groups. A slice group can contain any macroblock locations, including non-adjacent macroblock locations. A slice in some profiles of H.264/AVC consists of at least one macroblock within a particular slice group in raster scan order.

The elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit and whether a coded slice contained in the NAL unit is a part of a reference picture or a non-reference picture.

H.264/AVC NAL unit header includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC standard includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture. The header for SVC and MVC NAL units may additionally contain various indications related to the scalability and multiview hierarchy.

In a draft HEVC standard, a two-byte NAL unit header is used for all specified NAL unit types. The first byte of the NAL unit header contains one reserved bit, a one-bit indication nal_ref_flag primarily indicating whether the picture carried in this access unit is a reference picture or a non-reference picture, and a six-bit NAL unit type indication. The second byte of the NAL unit header includes a three-bit temporal_id indication for temporal level and a five-bit reserved field (called reserved_one_{—}5bits) required to have a value equal to 1 in a draft HEVC standard. The temporal_id syntax element may be regarded as a temporal identifier for the NAL unit.

The five-bit reserved field is expected to be used by extensions such as a future scalable and 3D video extension. It is expected that these five bits would carry information on the scalability hierarchy, such as quality_id or similar, dependency_id or similar, any other type of layer identifier, view order index or similar, view identifier, an identifier similar to priority_id of SVC indicating a valid sub-bitstream extraction if all NAL units greater than a specific identifier value are removed from the bitstream. Without loss of generality, in some example embodiments a variable Layerld is derived from the value of reserved_one_{—}5bits, which may also be referred to as layer_id_plus1, for example as follows:

LayerId=reserved_one_{—}5bits−1.

NAL units can be categorized into Video Coding Layer (VCL) NAL units and non-VCL NAL units. VCL NAL units are typically coded slice NAL units. In H.264/AVC, coded slice NAL units contain syntax elements representing one or more coded macroblocks, each of which corresponds to a block of samples in the uncompressed picture. In HEVC, coded slice NAL units contain syntax elements representing one or more CU. In H.264/AVC and HEVC a coded slice NAL unit can be indicated to be a coded slice in an Instantaneous Decoding Refresh (IDR) picture or coded slice in a non-IDR picture. In HEVC, a coded slice NAL unit can be indicated to be a coded slice in a Clean Decoding Refresh (CDR) picture (which may also be referred to as a Clean Random Access picture or a CRA picture).

A non-VCL NAL unit may be for example one of the following types: a sequence parameter set, a picture parameter set, a supplemental enhancement information (SEI) NAL unit, an access unit delimiter, an end of sequence NAL unit, an end of stream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. There are three NAL units specified in H.264/AVC to carry sequence parameter sets: the sequence parameter set NAL unit containing all the data for H.264/AVC VCL NAL units in the sequence, the sequence parameter set extension NAL unit containing the data for auxiliary coded pictures, and the subset sequence parameter set for MVC and SVC VCL NAL units. In a draft HEVC standard a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In a draft HEVC, there is also a third type of parameter sets, here referred to as an Adaptation Parameter Set (APS), which includes parameters that are likely to be unchanged in several coded slices but may change for example for each picture or each few pictures. In a draft HEVC, the APS syntax structure includes parameters or syntax elements related to quantization matrices (QM), adaptive sample offset (SAO), adaptive loop filtering (ALF), and deblocking filtering. In a draft HEVC, an APS is a NAL unit and coded without reference or prediction from any other NAL unit. An identifier, referred to as aps_id syntax element, is included in APS NAL unit, and included and used in the slice header to refer to a particular APS. In another draft HEVC standard, an APS syntax structure only contains ALF parameters. In a draft HEVC standard, an adaptation parameter set RBSP includes parameters that can be referred to by the coded slice NAL units of one or more coded pictures when at least one of sample_adaptive_offset_enabled_flag or adaptive_loop_filter_enabled_flag are equal to 1.

A draft HEVC standard also includes a fourth type of a parameter set, called a video parameter set (VPS), which was proposed for example in document JCTVC-H0388 (http://phenix.int-evry.fr/jct/doc_end_user/documents/8_San%20Jose/wg11/JCTVC-H0388-v4.zip). A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3DV. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. In a scalable extension of HEVC, VPS may for example include a mapping of the LayerId value derived from the NAL unit header to one or more scalability dimension values, for example correspond to dependency_id, quality_id, view_id, and depth_flag for the layer defined similarly to SVC and MVC. VPS may include profile and level information for one or more layers as well as the profile and/or level for one or more temporal sub-layers (consisting of VCL NAL units at and below certain temporal_id values) of a layer representation.

H.264/AVC and HEVC syntax allows many instances of parameter sets, and each instance is identified with a unique identifier. In order to limit the memory usage needed for parameter sets, the value range for parameter set identifiers has been limited. In H.264/AVC and a draft HEVC standard, each slice header includes the identifier of the picture parameter set that is active for the decoding of the picture that contains the slice, and each picture parameter set contains the identifier of the active sequence parameter set. In a HEVC standard, a slice header additionally contains an APS identifier. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a parameter in the session description for Real-time Transport Protocol (RTP) sessions. If parameter sets are transmitted in-band, they can be repeated to improve error robustness.

A parameter sets may be activated by a reference from a slice or from another active parameter set or in some cases from another syntax structure such as a buffering period SEI message.

A SEI NAL unit may contain one or more SEI messages, which are not required for the decoding of output pictures but may assist in related processes, such as picture output timing, rendering, error detection, error concealment, and resource reservation. Several SEI messages are specified in H.264/AVC and HEVC, and the user data SEI messages enable organizations and companies to specify SEI messages for their own use. H.264/AVC and HEVC contain the syntax and semantics for the specified SEI messages but no process for handling the messages in the recipient is defined. Consequently, encoders are required to follow the H.264/AVC standard or the HEVC standard when they create SEI messages, and decoders conforming to the H.264/AVC standard or the HEVC standard, respectively, are not required to process SEI messages for output order conformance. One of the reasons to include the syntax and semantics of SEI messages in H.264/AVC and HEVC is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

A coded picture is a coded representation of a picture. A coded picture in H.264/AVC comprises the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit comprises a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next. In H.264/AVC, the coded slice of the primary coded picture may be followed by coded slices for zero or more redundant coded pictures. A redundant coded picture is a coded representation of a picture or a part of a picture. A redundant coded picture may be decoded if the primary coded picture is not received by the decoder for example due to a loss in transmission or a corruption in physical storage medium.

In H.264/AVC, an access unit may also include an auxiliary coded picture, which is a picture that supplements the primary coded picture and may be used for example in the display process. An auxiliary coded picture may for example be used as an alpha channel or alpha plane specifying the transparency level of the samples in the decoded pictures. An alpha channel or plane may be used in a layered composition or rendering system, where the output picture is formed by overlaying pictures being at least partly transparent on top of each other. An auxiliary coded picture has the same syntactic and semantic restrictions as a monochrome redundant coded picture. In H.264/AVC, an auxiliary coded picture contains the same number of macroblocks as the primary coded picture.

A coded video sequence is defined to be a sequence of consecutive access units in decoding order from an IDR access unit, inclusive, to the next IDR access unit, exclusive, or to the end of the bitstream, whichever appears earlier.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An H.264/AVC decoder can recognize an intra picture starting an open GOP from the recovery point SEI message in an H.264/AVC bitstream. An HEVC decoder can recognize an intra picture starting an open GOP, because a specific NAL unit type, CRA NAL unit type, is used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP starts from an IDR access unit. As a result, closed GOP structure has more error resilience potential in comparison to the open GOP structure, however at the cost of possible reduction in the compression efficiency. Open GOP coding structure is potentially more efficient in the compression, due to a larger flexibility in selection of reference pictures.

The bitstream syntax of H.264/AVC and HEVC indicates whether a particular picture is a reference picture for inter prediction of any other picture. Pictures of any coding type (I, P, B) can be reference pictures or non-reference pictures in H.264/AVC and HEVC. The NAL unit header indicates the type of the NAL unit and whether a coded slice contained in the NAL unit is a part of a reference picture or a non-reference picture.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in a draft HEVC standard, a combined list (List C) is constructed after the final reference picture lists (List 0 and List 1) have been constructed. The combined list may be used for uni-prediction (also known as uni-directional prediction) within B slices.

A reference picture list, such as reference picture list 0 and reference picture list 1, is typically constructed in two steps: First, an initial reference picture list is generated. The initial reference picture list may be generated for example on the basis of frame_num, POC, temporal_id, or information on the prediction hierarchy such as GOP structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list.

A coding technique known as isolated regions is based on constraining in-picture prediction and inter prediction jointly. An isolated region in a picture can contain any macroblock (or alike) locations, and a picture can contain zero or more isolated regions that do not overlap. A leftover region, if any, is the area of the picture that is not covered by any isolated region of a picture. When coding an isolated region, at least some types of in-picture prediction is disabled across its boundaries. A leftover region may be predicted from isolated regions of the same picture.

A coded isolated region can be decoded without the presence of any other isolated or leftover region of the same coded picture. It may be necessary to decode all isolated regions of a picture before the leftover region. In some implementations, an isolated region or a leftover region contains at least one slice.

Pictures, whose isolated regions are predicted from each other, may be grouped into an isolated-region picture group. An isolated region can be inter-predicted from the corresponding isolated region in other pictures within the same isolated-region picture group, whereas inter prediction from other isolated regions or outside the isolated-region picture group may be disallowed. A leftover region may be inter-predicted from any isolated region. The shape, location, and size of coupled isolated regions may evolve from picture to picture in an isolated-region picture group.

Coding of isolated regions in the H.264/AVC codec may be based on slice groups. The mapping of macroblock locations to slice groups may be specified in the picture parameter set. The H.264/AVC syntax includes syntax to code certain slice group patterns, which can be categorized into two types, static and evolving. The static slice groups stay unchanged as long as the picture parameter set is valid, whereas the evolving slice groups can change picture by picture according to the corresponding parameters in the picture parameter set and a slice group change cycle parameter in the slice header. The static slice group patterns include interleaved, checkerboard, rectangular oriented, and freeform. The evolving slice group patterns include horizontal wipe, vertical wipe, box-in, and box-out. The rectangular oriented pattern and the evolving patterns are especially suited for coding of isolated regions and are described more carefully in the following.

For a rectangular oriented slice group pattern, a desired number of rectangles are specified within the picture area. A foreground slice group includes the macroblock locations that are within the corresponding rectangle but excludes the macroblock locations that are already allocated by slice groups specified earlier. A leftover slice group contains the macroblocks that are not covered by the foreground slice groups.

An evolving slice group is specified by indicating the scan order of macroblock locations and the change rate of the size of the slice group in number of macroblocks per picture. Each coded picture is associated with a slice group change cycle parameter (conveyed in the slice header). The change cycle multiplied by the change rate indicates the number of macroblocks in the first slice group. The second slice group contains the rest of the macroblock locations.

In H.264/AVC In-picture prediction is disabled across slice group boundaries, because slice group boundaries lie in slice boundaries. Therefore each slice group is an isolated region or leftover region.

Each slice group has an identification number within a picture. Encoders can restrict the motion vectors in a way that they only refer to the decoded macroblocks belonging to slice groups having the same identification number as the slice group to be encoded. Encoders should take into account the fact that a range of source samples is needed in fractional pixel interpolation and all the source samples should be within a particular slice group.

The H.264/AVC codec includes a deblocking loop filter. Loop filtering is applied to each 4×4 block boundary, but loop filtering can be turned off by the encoder at slice boundaries. If loop filtering is turned off at slice boundaries, perfect reconstructed pictures at the decoder can be achieved when performing gradual random access. Otherwise, reconstructed pictures may be imperfect in content even after the recovery point.

The recovery point SEI message and the motion constrained slice group set SEI message of the H.264/AVC standard can be used to indicate that some slice groups are coded as isolated regions with restricted motion vectors. Decoders may utilize the information for example to achieve faster random access or to save in processing time by ignoring the leftover region.

A sub-picture concept has been proposed for HEVC e.g. in document JCTVC-I0356<http://phenix.int-evry.fr/jct/doc_end_user/documents/9_Geneva/wg11/JCTVC-I0356-v1.zip>, which is similar to rectangular isolated regions or rectangular motion-constrained slice group sets of h.264/AVC. The sub-picture concept proposed in JCTVC-I0356 is described in the following, while it should be understood that sub-pictures may be defined otherwise similarly but not identically to what is described below. In the sub-picture concept, the picture is partitioned into predefined rectangular regions. Each sub-picture would be processed as an independent picture except that all sub-pictures constituting a picture share the same global information such as SPS, PPS and reference picture sets. Sub-pictures are similar to tiles geometrically. Their properties are as follows: They are LCU-aligned rectangular regions specified at sequence level. Sub-pictures in a picture may be scanned in sub-picture raster scan of the picture. Each sub-picture starts a new slice. If multiple tiles are present in a picture, sub-picture boundaries and tiles boundaries may be aligned. There may be no loop filtering across sub-pictures. There may be no prediction of sample value and motion info outside the sub-picture, and no sample value at a fractional sample position that is derived using one or more sample values outside the sub-picture may be used to inter predict any sample within the sub-picture. If motion vectors point to regions outside of a sub-picture, a padding process defined for picture boundaries may be applied. LCUs are scanned in raster order within sub-pictures unless a sub-picture contains more than one tile. Tiles within a sub-picture are scanned in tile raster scan of the sub-picture. Tiles cannot cross sub-picture boundaries except for the default one tile per picture case. All coding mechanisms that are available at picture level are supported at sub-picture level.

Scalable video coding refers to coding structure where one bitstream can contain multiple representations of the content at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

In some scalable video coding schemes, a video signal can be encoded into a base layer and one or more enhancement layers. An enhancement layer may enhance the temporal resolution (i.e., the frame rate), the spatial resolution, or simply the quality of the video content represented by another layer or part thereof. Each layer together with all its dependent layers is one representation of the video signal at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Some coding standards allow creation of scalable bit streams. A meaningful decoded representation can be produced by decoding only certain parts of a scalable bit stream. Scalable bit streams can be used for example for rate adaptation of pre-encoded unicast streams in a streaming server and for transmission of a single bit stream to terminals having different capabilities and/or with different network conditions. A list of some other use cases for scalable video coding can be found in the ISO/IEC JTC1 SC29 WG11 (MPEG) output document N5540, “Applications and Requirements for Scalable Video Coding”, the 64^{th} MPEG meeting, Mar. 10 to 14, 2003, Pattaya, Thailand.

In some cases, data in an enhancement layer can be truncated after a certain location, or even at arbitrary positions, where each truncation position may include additional data representing increasingly enhanced visual quality. Such scalability is referred to as fine-grained (granularity) scalability (FGS).

SVC uses an inter-layer prediction mechanism, wherein certain information can be predicted from layers other than the currently reconstructed layer or the next lower layer. Information that could be inter-layer predicted includes intra texture, motion and residual data. Inter-layer motion prediction includes the prediction of block coding mode, header information, etc., wherein motion from the lower layer may be used for prediction of the higher layer. In case of intra coding, a prediction from surrounding macroblocks or from co-located macroblocks of lower layers is possible. These prediction techniques do not employ information from earlier coded access units and hence, are referred to as intra prediction techniques. Furthermore, residual data from lower layers can also be employed for prediction of the current layer.

SVC specifies a concept known as single-loop decoding. It is enabled by using a constrained intra texture prediction mode, whereby the inter-layer intra texture prediction can be applied to macroblocks (MBs) for which the corresponding block of the base layer is located inside intra-MBs. At the same time, those intra-MBs in the base layer use constrained intra-prediction (e.g., having the syntax element “constrained_intra_pred_flag” equal to 1). In single-loop decoding, the decoder performs motion compensation and full picture reconstruction only for the scalable layer desired for playback (called the “desired layer” or the “target layer”), thereby greatly reducing decoding complexity. All of the layers other than the desired layer do not need to be fully decoded because all or part of the data of the MBs not used for inter-layer prediction (be it inter-layer intra texture prediction, inter-layer motion prediction or inter-layer residual prediction) is not needed for reconstruction of the desired layer.

A single decoding loop is needed for decoding of most pictures, while a second decoding loop is selectively applied to reconstruct the base representations, which are needed as prediction references but not for output or display, and are reconstructed only for the so called key pictures (for which “store_ref_base_pic_flag” is equal to 1).

FGS was included in some draft versions of the SVC standard, but it was eventually excluded from the final SVC standard. FGS is subsequently discussed in the context of some draft versions of the SVC standard. The scalability provided by those enhancement layers that cannot be truncated is referred to as coarse-grained (granularity) scalability (CGS). It collectively includes the traditional quality (SNR) scalability and spatial scalability. The SVC standard supports the so-called medium-grained scalability (MGS), where quality enhancement pictures are coded similarly to SNR scalable layer pictures but indicated by high-level syntax elements similarly to FGS layer pictures, by having the quality_id syntax element greater than 0.

The scalability structure in the SVC draft may be characterized by three syntax elements: “temporal_id,” “dependency_id” and “quality_id.” The syntax element “temporal_id” is used to indicate the temporal scalability hierarchy or, indirectly, the frame rate. A scalable layer representation comprising pictures of a smaller maximum “temporal_id” value has a smaller frame rate than a scalable layer representation comprising pictures of a greater maximum “temporal_id”. A given temporal layer typically depends on the lower temporal layers (i.e., the temporal layers with smaller “temporal_id” values) but does not depend on any higher temporal layer. The syntax element “dependency_id” is used to indicate the CGS inter-layer coding dependency hierarchy (which, as mentioned earlier, includes both SNR and spatial scalability). At any temporal level location, a picture of a smaller “dependency_id” value may be used for inter-layer prediction for coding of a picture with a greater “dependency_id” value. The syntax element “quality_id” is used to indicate the quality level hierarchy of a FGS or MGS layer. At any temporal location, and with an identical “dependency_id” value, a picture with “quality_id” equal to QL uses the picture with “quality_id” equal to QL-1 for inter-layer prediction. A coded slice with “quality_id” larger than 0 may be coded as either a truncatable FGS slice or a non-truncatable MGS slice.

For simplicity, all the data units (e.g., Network Abstraction Layer units or NAL units in the SVC context) in one access unit having identical value of “dependency_id” are referred to as a dependency unit or a dependency representation. Within one dependency unit, all the data units having identical value of “quality_id” are referred to as a quality unit or layer representation.

A base representation, also known as a decoded base picture, is a decoded picture resulting from decoding the Video Coding Layer (VCL) NAL units of a dependency unit having “quality_id” equal to 0 and for which the “store_ref_base_pic_flag” is set equal to 1. An enhancement representation, also referred to as a decoded picture, results from the regular decoding process in which all the layer representations that are present for the highest dependency representation are decoded.

As mentioned earlier, CGS includes both spatial scalability and SNR scalability. Spatial scalability is initially designed to support representations of video with different resolutions. For each time instance, VCL NAL units are coded in the same access unit and these VCL NAL units can correspond to different resolutions. During the decoding, a low resolution VCL NAL unit provides the motion field and residual which can be optionally inherited by the final decoding and reconstruction of the high resolution picture. When compared to older video compression standards, SVC's spatial scalability has been generalized to enable the base layer to be a cropped and zoomed version of the enhancement layer.

MGS quality layers are indicated with “quality_id” similarly as FGS quality layers. For each dependency unit (with the same “dependency_id”), there is a layer with “quality_id” equal to 0 and there can be other layers with “quality_id” greater than 0. These layers with “quality_id” greater than 0 are either MGS layers or FGS layers, depending on whether the slices are coded as truncatable slices.

In the basic form of FGS enhancement layers, only inter-layer prediction is used. Therefore, FGS enhancement layers can be truncated freely without causing any error propagation in the decoded sequence. However, the basic form of FGS suffers from low compression efficiency. This issue arises because only low-quality pictures are used for inter prediction references. It has therefore been proposed that FGS-enhanced pictures be used as inter prediction references. However, this may cause encoding-decoding mismatch, also referred to as drift, when some FGS data are discarded.

One feature of a draft SVC standard is that the FGS NAL units can be freely dropped or truncated, and a feature of the SVCV standard is that MGS NAL units can be freely dropped (but cannot be truncated) without affecting the conformance of the bitstream. As discussed above, when those FGS or MGS data have been used for inter prediction reference during encoding, dropping or truncation of the data would result in a mismatch between the decoded pictures in the decoder side and in the encoder side. This mismatch is also referred to as drift.

To control drift due to the dropping or truncation of FGS or MGS data, SVC applied the following solution: In a certain dependency unit, a base representation (by decoding only the CGS picture with “quality_id” equal to 0 and all the dependent-on lower layer data) is stored in the decoded picture buffer. When encoding a subsequent dependency unit with the same value of “dependency_id,” all of the NAL units, including FGS or MGS NAL units, use the base representation for inter prediction reference. Consequently, all drift due to dropping or truncation of FGS or MGS NAL units in an earlier access unit is stopped at this access unit. For other dependency units with the same value of “dependency_id,” all of the NAL units use the decoded pictures for inter prediction reference, for high coding efficiency.

Each NAL unit includes in the NAL unit header a syntax element “use_ref_base_pic_flag.” When the value of this element is equal to 1, decoding of the NAL unit uses the base representations of the reference pictures during the inter prediction process. The syntax element “store_ref_base_pic_flag” specifies whether (when equal to 1) or not (when equal to 0) to store the base representation of the current picture for future pictures to use for inter prediction.

NAL units with “quality_id” greater than 0 do not contain syntax elements related to reference picture lists construction and weighted prediction, i.e., the syntax elements “num_ref_active_lx_minus1” (x=0 or 1), the reference picture list reordering syntax table, and the weighted prediction syntax table are not present. Consequently, the MGS or FGS layers have to inherit these syntax elements from the NAL units with “quality_id” equal to 0 of the same dependency unit when needed.

In SVC, a reference picture list consists of either only base representations (when “use_ref_base_pic_flag” is equal to 1) or only decoded pictures not marked as “base representation” (when “use_ref_base_pic_flag” is equal to 0), but never both at the same time.

A scalable nesting SEI message has been specified in SVC. The scalable nesting SEI message provides a mechanism for associating SEI messages with subsets of a bitstream, such as indicated dependency representations or other scalable layers. A scalable nesting SEI message contains one or more SEI messages that are not scalable nesting SEI messages themselves. An SEI message contained in a scalable nesting SEI message is referred to as a nested SEI message. An SEI message not contained in a scalable nesting SEI message is referred to as a non-nested SEI message.

A scalable video codec for quality scalability (also known as Signal-to-Noise or SNR) and/or spatial scalability may be implemented as follows. For a base layer, a conventional non-scalable video encoder and decoder are used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use typically with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability following scalability modes exist:
Spatial scalability: Base layer pictures are coded at a lower resolution than enhancement layer pictures.
Bit-depth scalability: Base layer pictures are coded at lower bit-depth (e.g. 8 bits) than enhancement layer pictures (e.g. 10 or 12 bits).
Chroma format scalability: Base layer pictures provide lower fidelity in chroma (e.g. coded in 4:2:0 chroma format) than enhancement layer pictures (e.g. 4:4:4 format).

In all of the above scalability cases, base layer information could be used to code enhancement layer to minimize the additional bitrate overhead.

For the cases where only an area within the picture is desired to be enhanced (as opposed to the entire picture), current scalable video coding solutions either have too much complexity overhead or suffer from poor coding efficiency.

For example, even if only an area within the video picture is targeted to be coded at higher bit-depth, the current scalable coding solutions nevertheless require the entire picture to be coded at high bit-depth, which drastically increases the complexity. This is due to many factors, such as motion compensated prediction requires a larger memory bandwidth as all the motion blocks would need to access higher bit-depth reference pixel samples. Also, interpolation and inverse transform requires 32-bit processing due to the higher bit-depth samples.

For the case of chroma format scalability, where certain region of the image is enhanced, the same problem happens. The reference memory of the entire picture should be in 4:4:4 format, again increasing the memory requirement. Similarly, if spatial scalability is to be applied only for a selected region (e.g. players and the ball in the case of sports broadcast), traditional methods require storing and maintaining the whole enhancement layer image in full resolution.

For the case of SNR scalability, if only a certain portion of the picture is enhanced by not transmitting any enhancement information for the rest of the picture outside the region of interest, a significant amount of control information needs to be signaled to indicate whether each of the blocks contain any enhancement information or not. This overhead needs to be signaled for every picture within the video sequence, hence reducing the coding efficiency of the video coder.

Now in order to enable encoding an area within an enhancement layer picture with increased quality and/or spatial resolution and with high coding efficiency, a concept of enhancement layer sub-picture is introduced herein. An aspect of the invention involves a method for encoding one or more enhancement layer sub-pictures for a given base-layer picture, said one or more enhancement layer sub-pictures having a size smaller than the corresponding enhancement layer reconstructed picture, the method comprising
encoding and reconstructing said base-layer picture;
encoding and reconstructing said one or more enhancement layer sub-pictures;
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

It should be understood that while term sub-picture is used to describe various embodiments, a sub-picture in the various embodiments may not have identical features to sub-pictures proposed for the HEVC standard, while some features may be the same or similar.

According to an embodiment, the method further comprises encoding predictively said one or more enhancement layer sub-pictures with respect to the base-layer picture.

According to an embodiment, the enhancement layer sub-pictures are allowed to be predictively coded with respect to earlier coded enhancement layer pictures.

According to an embodiment, the enhancement layer sub-pictures contain enhancement information to the corresponding base layer picture, the enhancement information including at least one of the following:
increasing the fidelity of the chroma of said one or more enhancement layer sub-pictures with respect to the chroma of the corresponding base layer picture;
increasing the bit-depth of said one or more enhancement layer sub-pictures with respect to the bit-depth of the corresponding base layer picture;
increasing the quality of said one or more enhancement layer sub-pictures with respect to the quality of the corresponding base layer picture; or
increasing the spatial resolution of said one or more enhancement layer sub-pictures with respect to the spatial resolution of the corresponding base layer picture.

Increasing the fidelity of the chroma means, for example, that for an enhancement layer sub-picture the chroma format could be 4:2:2 or 4:4:4, whereas for base layer picture the chroma format is 4:2:0. In 4:2:0 sampling, each of the two chroma arrays or pictures has half the height and half the width of the luma or picture array. In 4:2:2 sampling, each of the two chroma arrays has the same height and half the width of the luma array. In 4:4:4 sampling, each of the two chroma arrays have the same height and width as the luma array.

Increasing the bit-depth means for example, that for an enhancement layer sub-picture the bit-depth of the samples could be 10 or 12-bit whereas for base-layer picture the bit-depth is 8 bit.

According to an embodiment, the enhancement layer information for sub-picture is coded with the same syntax as it would be coded for an enhancement layer picture. Additionally, there may be additional syntax, such as syntax elements added to a sequence parameter set indicating the location of the sub-picture relative to the sampling grid of the base layer picture or the base layer picture upsampled to match the resolution of the enhancement layer, for example.

Another aspect of the invention involves a method for decoding one or more enhancement layer sub-pictures for a given base-layer picture, said one or more enhancement layer sub-pictures having a size smaller than the corresponding enhancement layer reconstructed picture, the method comprising
decoding said base-layer picture;
decoding said one or more enhancement layer sub-pictures;
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to an embodiment, if spatial scalability is used, then samples outside the enhancement layer sub-picture area are copied from an upsampled base-layer picture.

According to an embodiment, decoding said one or more enhancement layer sub-pictures utilizes information from the base layer.

Alternatively, the reconstruction process could be defined separately for base layer and enhancement layer sub-pictures and the enhancement layer (base layer+enhancement layer sub-picture) could be generated by various means without using any pre-defined methods. In that case, the enhancement layer is not placed in the reference picture buffer and subsequent pictures do not utilize information from the reconstructed enhancement layer.

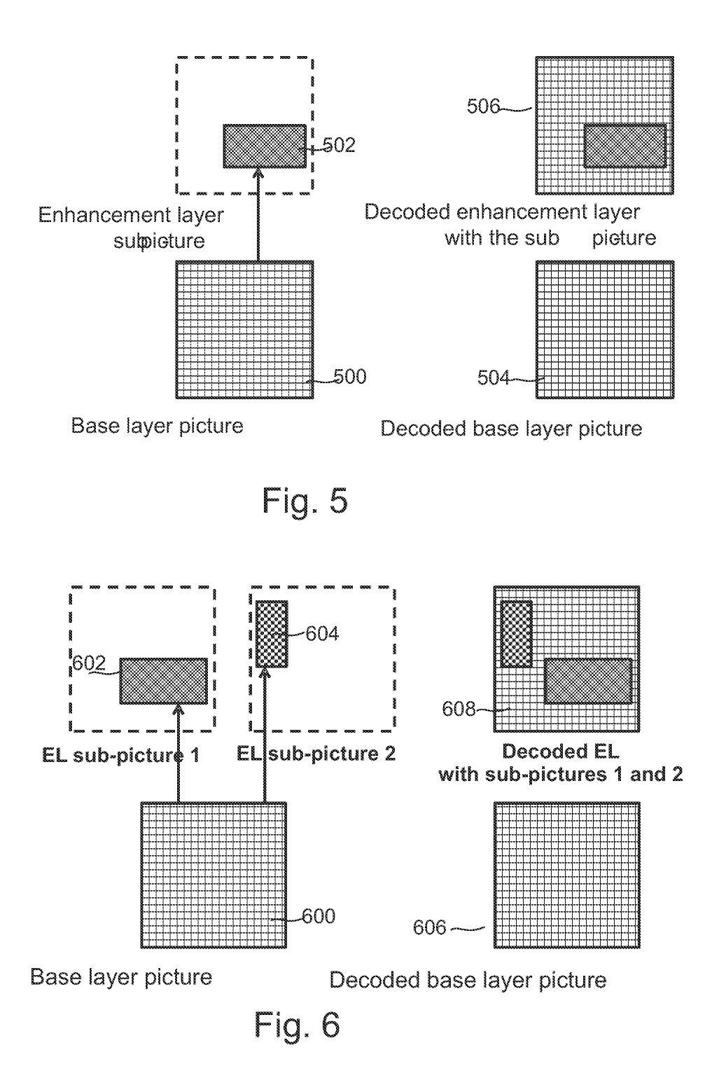

Embodiments of the encoding and decoding processes are illustrated in FIGS. 5 and 6.

In FIG. 5, a region of a video picture is encoded as an enhancement layer sub-picture 502 with enhanced encoding parameter values compared to the co-located region in the base-layer picture 500. The enhancement layer sub-picture 502 may be predictively encoded from the base-layer picture 500, and possibly from one or more earlier coded enhancement layer sub-pictures. A bitstream containing the encoded base-layer picture 500 and the enhancement layer sub-picture 502 is transmitted to a decoder, which decodes the encoded base-layer picture as a decoded base-layer picture 504. The decoder also decodes the encoded enhancement layer sub-picture, whereafter the enhancement layer picture 506 is constructed by copying samples outside the enhancement layer sub-picture area from the decoded base layer picture to the enhancement layer picture and copying samples within the enhancement layer sub-picture area from the decoded enhancement layer sub-picture to the enhancement layer picture.

In FIG. 6, two regions of a video picture are encoded as enhancement layer sub-pictures 602, 604 with enhanced encoding parameter values compared to the co-located regions in the base-layer picture 600. Again, either or both of the enhancement layer sub-pictures 602, 604 may be predictively encoded from the base-layer picture 500, and possibly from one or more earlier coded enhancement layer sub-pictures. A bitstream containing the encoded base-layer picture 600 and the enhancement layer sub-pictures 602, 604 is transmitted to a decoder, which decodes the encoded base-layer picture as a decoded base-layer picture 606. The decoder decodes both of the encoded enhancement layer sub-pictures, and then the enhancement layer picture 608 is constructed by copying samples outside the enhancement layer sub-pictures area from the decoded base layer picture to the enhancement layer picture and copying samples within the enhancement layer sub-pictures area from the decoded enhancement layer sub-pictures to the enhancement layer picture.

The enhancement layer sub-pictures may be utilized in various implementation alternatives, some of which are discussed below as specific embodiments.

According to an embodiment, the upper-left corner of the enhancement layer sub-picture may be aligned to the upper-left corner of a largest coding unit (LCU) of the picture.

According to an embodiment, the size of the enhancement layer sub-picture may be restricted to integer multiples (1, 2, 3, 4, . . . ) of the size of the largest coding unit (LCU) or the size of the prediction unit (PU) or the size of the coding unit (CU).

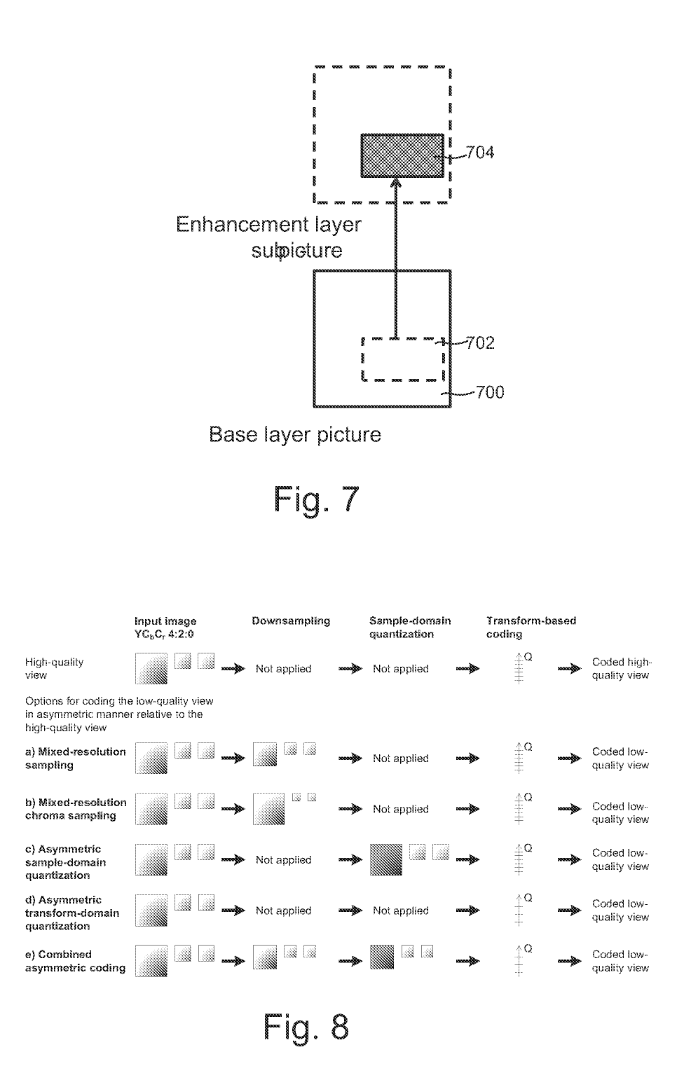

According to an embodiment, if the enhancement layer sub-picture is coded predictively with respect to base layer, the prediction process may be restricted so that only the pixels within the co-located area of base layer picture could be used. This is illustrated in FIG. 7, where only reference samples from the co-located area 702 of the base-layer picture 700 are allowed to be used, when defining the enhancement layer sub-picture 704. In some embodiments, the base layer may also contain a sub-picture such as an isolated region, which is co-located with the enhancement layer sub-picture. In some embodiments, the sub-picture of the enhancement layer may use prediction from the base layer in encoding and/or decoding, but the prediction is limited to use samples only within the sub-picture of the base layer.

According to an embodiment, the number of enhancement layer sub-pictures could change for different pictures or stay fixed.

According to an embodiment, if the enhancement layer sub-picture is coded predictively with respect to base layer, the prediction process may involve different image processing operations. For example, conversion operations from one color space (e.g. from YUV color space) to another color space (e.g. to RGB color space) may be applied.

According to an embodiment, a first enhancement layer sub-picture may enhance different characteristics of the image than a second enhancement layer sub-picture. For example, in FIG. 6 the enhancement layer sub-picture 602 may provide chroma format enhancement, while the enhancement layer sub-picture 604 may provide bit-depth enhancement.

According to an embodiment, single enhancement layer sub-picture may enhance multiple characteristics of the image. For example, in FIG. 5 the enhancement layer sub-picture 502 may provide both chroma format enhancement and bit-depth enhancement.

According to an embodiment, the size and location of the enhancement layer sub-pictures may change for different pictures or stay fixed.

According to an embodiment, the position and size of the enhancement layer sub-pictures may be the same as tiles or slices used in the base layer picture.

According to an embodiment, the size and position of enhancement layer sub-pictures may be restricted so they are spatially non-overlapping.

According to an embodiment, the size and position of enhancement layer sub-pictures may be allowed to be spatially overlapping.

According to an embodiment, the enhancement layer sub-picture concept could be implemented in the form of Supplemental Enhancement Information (SEI) message. For example, a motion-constrained tile set SEI message may indicate a set of tile indexes or addresses alike within an indicated or inferred group of pictures, such as within the coded video sequence, that form an isolated-region picture group. The motion-constrained tile set SEI message may be indicated to be specific for a scalable layer, for example by enclosing it within a scalable nesting SEI message or alike. When a motion-constrained tile set SEI message is indicated to be specific to a non-base layer, it may be additionally indicated or inferred to avoid inter-layer prediction from areas outside the sub-picture area on the base layer or other layer used for inter-layer prediction. It may be additionally indicated for an enhancement layer sub-picture that areas outside that are inter-layer predicted with zero or non-existing prediction error. Additionally or alternatively, some picture properties, such as quantization parameter, within an enhancement layer sub-picture may differ from those outside the enhancement layer sub-picture. Additionally or alternatively, some picture properties may be changed as pre-processing for encoding—for example, the areas outside the enhancement layer sub-picture may be low-pass filtered prior to encoding such that the area within the sub-picture has essentially greater spatially fidelity. Similarly even if a higher bit-depth (e.g. 10 bits) was used for encoding the entire picture, the areas outside an enhancement layer sub-picture may be pre-processed prior to encoding or constrained during the encoding to effectively have 8-bit color depth.

Frame packing refers to a method where more than one frame is packed into a single frame at the encoder side as a pre-processing step for encoding and then the frame-packed frames are encoded with a conventional 2D video coding scheme. The output frames produced by the decoder therefore contain constituent frames of that correspond to the input frames spatially packed into one frame in the encoder side. Frame packing may be used for stereoscopic video, where a pair of frames, one corresponding to the left eye/camera/view and the other corresponding to the right eye/camera/view, is packed into a single frame. Frame packing may also or alternatively be used for depth or disparity enhanced video, where one of the constituent frames represents depth or disparity information corresponding to another constituent frame containing the regular color information (luma and chroma information). The use of frame-packing may be signaled in the video bitstream, for example using the frame packing arrangement SEI message of H.264/AVC or similar. The use of frame-packing may also or alternatively be indicated over video interfaces, such as High-Definition Multimedia Interface (HDMI). The use of frame-packing may also or alternatively be indicated and/or negotiated using various capability exchange and mode negotiation protocols, such as Session Description Protocol (SDP).

Depth-enhanced video refers to texture video having one or more views associated with depth video having one or more depth views. A number of approaches may be used for representing of depth-enhanced video, including the use of video plus depth (V+D), multiview video plus depth (MVD), and layered depth video (LDV). In the video plus depth (V+D) representation, a single view of texture and the respective view of depth are represented as sequences of texture picture and depth pictures, respectively. The MVD representation contains a number of texture views and respective depth views. In the LDV representation, the texture and depth of the central view are represented conventionally, while the texture and depth of the other views are partially represented and cover only the dis-occluded areas required for correct view synthesis of intermediate views.

According to an embodiment, the invention may be applied for frame-packed video containing a video-plus-depth representation, i.e. a texture frame and a depth frame, for example in a side-by-side frame packing arrangement. The base layer of a frame-packed frame may have the same chroma format or constituent frames may have a different chroma format such as 4:2:0 for the texture constituent frame and luma-only format for the depth constituent frame. The enhancement layer of a frame-packed frame may only concern one of the constituent frames of the base-layer frame-packed frame. For example, the enhancement layer may contain one or more of the following:
a chroma format enhancement for the texture constituent frame
a bit-depth enhancement for the texture constituent frame or the depth constituent frame
a spatial enhancement for the texture constituent frame or the depth constituent frame

A further branch of research for obtaining compression improvement in stereoscopic video is known as asymmetric stereoscopic video coding, in which there is a quality difference between the two coded views. This is attributed to the widely believed assumption that the Human Visual System (HVS) fuses the stereoscopic image pair such that the perceived quality is close to that of the higher quality view. Thus, compression improvement may be obtained by providing a quality difference between the two coded views.

Asymmetry between the two views can be achieved, for example, by one or more of the following methods:
a) Mixed-resolution (MR) stereoscopic video coding, also referred to as resolution-asymmetric stereoscopic video coding, where the views have different spatial resolution and/or different frequency-domain characteristics. Typically, one of the views is low-pass filtered and hence has a smaller amount of spatial details or a lower spatial resolution. Furthermore, the low-pass filtered view is usually sampled with a coarser sampling grid, i.e., represented by fewer pixels.
b) Mixed-resolution chroma sampling. The chroma pictures of one view are represented by fewer samples than the respective chroma pictures of the other view.
c) Asymmetric sample-domain quantization. The sample values of the two views are quantized with a different step size. For example, the luma samples of one view may be represented with the range of 0 to 255 (i.e., 8 bits per sample) while the range may be scaled to the range of 0 to 159 for the second view. Thanks to fewer quantization steps, the second view can be compressed with a higher ratio compared to the first view. Different quantization step sizes may be used for luma and chroma samples. As a special case of asymmetric sample-domain quantization, one can refer to bit-depth-asymmetric stereoscopic video when the number of quantization steps in each view matches a power of two.
d) Asymmetric transform-domain quantization. The transform coefficients of the two views are quantized with a different step size. As a result, one of the views has a lower fidelity and may be subject to a greater amount of visible coding artifacts, such as blocking and ringing.
e) A combination of different encoding techniques above.

The aforementioned types of asymmetric stereoscopic video coding are illustrated in FIG. 8. The first row presents the higher quality view which is only transform-coded. The remaining rows present several encoding combinations which have been investigated to create the lower quality view using different steps, namely, downsampling, sample domain quantization, and transform based coding. It can be observed from FIG. 8 that downsampling or sample-domain quantization can be applied or skipped regardless of how other steps in the processing chain are applied. Likewise, the quantization step in the transform-domain coding step can be selected independently of the other steps. Thus, practical realizations of asymmetric stereoscopic video coding may use appropriate techniques for achieving asymmetry in a combined manner as illustrated in row e) of FIG. 8.

According to an embodiment, the invention may be applied for frame-packed video containing stereoscopic or multiview video representation for example in a side-by-side frame packing arrangement. The base layer of a frame-packed frame may represent symmetric stereoscopic video, where both views have approximately equal visual quality, or the base layer of a frame-packed frame may represent asymmetric stereoscopic video. The enhancement layer of a frame-packed frame may only concern one of the constituent frames of the base-layer frame-packed frame. The enhancement layer may be coded to utilize asymmetric stereoscopic video coding or it may be coded to provide symmetric stereoscopic video representation in case the base layer was coded as asymmetric stereoscopic video. For example, the enhancement layer may contain one or more of the following:
a spatial enhancement for one of the constituent frames
a quality enhancement for one of the constituent frames
a chroma format enhancement for one of the constituent frames
a bit-depth enhancement for one of the constituent frames

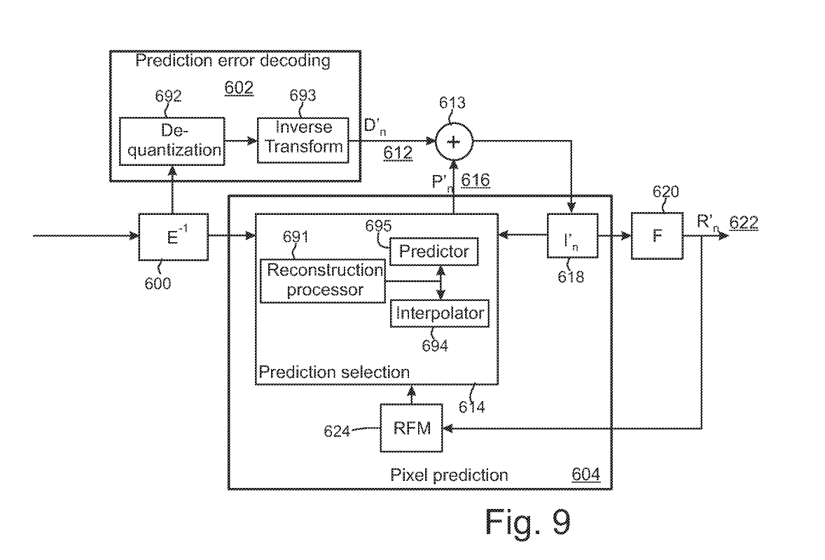

Another aspect of the invention is operation of the decoder when it receives the base-layer picture and at least one enhancement layer sub-picture. FIG. 9 shows a block diagram of a video decoder suitable for employing embodiments of the invention.

The decoder includes an entropy decoder 600 which performs entropy decoding on the received signal as an inverse operation to the entropy encoder 330 of the encoder described above. The entropy decoder 600 outputs the results of the entropy decoding to a prediction error decoder 602 and pixel predictor 604.

The pixel predictor 604 receives the output of the entropy decoder 600. A predictor selector 614 within the pixel predictor 604 determines that an intra-prediction, an inter-prediction, or interpolation operation is to be carried out. The predictor selector may furthermore output a predicted representation of an image block 616 to a first combiner 613. The predicted representation of the image block 616 is used in conjunction with the reconstructed prediction error signal 612 to generate a preliminary reconstructed image 618. The preliminary reconstructed image 618 may be used in the predictor 614 or may be passed to a filter 620. The filter 620 applies a filtering which outputs a final reconstructed signal 622. The final reconstructed signal 622 may be stored in a reference frame memory 624, the reference frame memory 624 further being connected to the predictor 614 for prediction operations.

The prediction error decoder 602 receives the output of the entropy decoder 600. A dequantizer 692 of the prediction error decoder 602 may dequantize the output of the entropy decoder 600 and the inverse transform block 693 may perform an inverse transform operation to the dequantized signal output by the dequantizer 692. The output of the entropy decoder 600 may also indicate that prediction error signal is not to be applied and in this case the prediction error decoder produces an all zero output signal.

Thus, in the above process, the decoder may first decode the base-layer picture, and then use it as a reference picture for inter-predicting the enhancement layer sub-picture. Then the decoder constructs the enhancement layer picture by the copying samples outside the enhancement layer sub-picture area from the decoded base layer picture to the enhancement layer picture and copying samples within the enhancement layer sub-picture area from the decoded enhancement layer sub-picture to the enhancement layer picture.

The decoded pictures may be placed in reference frame buffer, as those may be used for decoding the subsequent frames using motion compensated prediction. In an example implementation, the encoder and/or the decoder places the decoded enhancement layer picture and base layer picture separately in the reference frame buffer. Alternatively, the encoder and/or the decoder could place only the enhancement layer sub-picture in the reference frame buffer and use the decoded enhancement layer picture as reference for base layer pictures similarly to SVC or other single-loop decoding schemes for scalable video coding. Another alternative is that the encoder and/or the decoder could place the enhancement layer sub-picture and the base-layer picture in reference frame buffer. Another alternative is that the encoder and/or decoder could place the enhancement layer sub-picture in a conceptually separate reference frame buffer to the reference frame buffer used for base layer reference pictures.

In addition, a process may be used in encoding and decoding to “down-convert” the enhancement layer sub-picture to the format used for the remaining parts of the enhancement layer, such as to the same bit-depth or the same chroma format. The down-converted enhancement-layer sub-picture and the remaining parts of the same picture could then be merged to form a single enhancement layer picture in a reference frame buffer which may be conceptually separate from that used for enhancement layer sub-picture encoding/decoding. Consequently, motion vectors of the prediction units outside the enhancement layer sub-picture need not be limited to use samples outside the sub-picture. The characteristics of the enhancement layer sub-picture placed in the reference frame buffer could be different than the enhancement layer picture or the base layer picture. For example, the bit-depth of enhancement layer sub-picture could be in 10-bits whereas the bit-depth of base-layer picture is 8-bits.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some or all common elements.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

A method according to a first embodiment comprises a method for encoding one or more enhancement layer sub-pictures for a given base-layer picture, said one or more enhancement layer sub-pictures having a size smaller than the corresponding enhancement layer reconstructed picture, the method comprising
encoding and reconstructing said base-layer picture;
encoding and reconstructing said one or more enhancement layer sub-pictures;
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to an embodiment, the method further comprises encoding predictively said one or more enhancement layer sub-pictures with respect to the base-layer picture.

According to an embodiment, the enhancement layer sub-pictures are allowed to be predictively coded with respect to earlier coded enhancement layer pictures.

According to an embodiment, the enhancement layer sub-pictures are allowed to be predictively coded with respect to earlier coded enhancement layer sub-pictures.

According to an embodiment, the enhancement layer sub-pictures contain enhancement information to the corresponding base layer picture, the enhancement information including at least one of the following:
increasing the fidelity of the chroma of said one or more enhancement layer sub-pictures with respect to the chroma of the corresponding base layer picture;
increasing the bit-depth of said one or more enhancement layer sub-pictures with respect to the bit-depth of the corresponding base layer picture;
increasing the quality of said one or more enhancement layer sub-pictures with respect to the quality of the corresponding base layer picture; or
increasing the spatial resolution of said one or more enhancement layer sub-pictures with respect to the spatial resolution of the corresponding base layer picture.

According to an embodiment, the enhancement layer information for sub-picture is coded with the same syntax as it would be coded for an enhancement layer picture.

According to an embodiment, the upper-left corner of the enhancement layer sub-picture may be aligned to the upper-left corner of a largest coding unit (LCU) of the picture.

According to an embodiment, the size of the enhancement layer sub-picture may be restricted to integer multiples (1, 2, 3, 4, . . . ) of the size of the largest coding unit (LCU) or the size of the prediction unit (PU) or the size of the coding unit (CU).

According to an embodiment, if the enhancement layer sub-picture is coded predictively with respect to base layer, the prediction process may be restricted so that only the pixels within the co-located area of base layer picture could be used.

According to an embodiment, the number of enhancement layer sub-pictures could change for different pictures or stay fixed.

According to an embodiment, if the enhancement layer sub-picture is coded predictively with respect to base layer, the prediction process may involve different image processing operations.

According to an embodiment, a first enhancement layer sub-picture may enhance different characteristics of the image than a second enhancement layer sub-picture.

According to an embodiment, single enhancement layer sub-picture may enhance multiple characteristics of the image.

According to an embodiment, the size and location of the enhancement layer sub-pictures may change for different pictures or stay fixed.

According to an embodiment, the position and size of the enhancement layer sub-pictures may be the same as tiles or slices used in the base layer picture.

According to an embodiment, the size and position of enhancement layer sub-pictures may be restricted so they are spatially non-overlapping.

According to an embodiment, the size and position of enhancement layer sub-pictures may be allowed to be spatially overlapping.

According to an embodiment, the enhancement layer sub-picture concept could be implemented in the form of Supplemental Enhancement Information (SEI) message.

According to an embodiment, the one or more enhancement layer sub-pictures is converted to the same format used in the samples outside the area of said reconstructed one or more enhancement layer sub-pictures copied from the reconstructed base layer picture to the reconstructed enhancement layer picture, and the converted enhancement-layer picture are merged to form a single enhancement layer picture in a reference frame buffer.

An apparatus according to a second embodiment comprises:
a video encoder configured for encoding a scalable bitstream comprising a base layer and at least one enhancement layer, wherein said video encoder is further configured for
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture;
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to a third embodiment there is provided a computer readable storage medium stored with code thereon for use by an apparatus, which when executed by a processor, causes the apparatus to perform:
encoding a scalable bitstream comprising a base layer and at least one enhancement layer;
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture; and
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to a fourth embodiment there is provided at least one processor and at least one memory, said at least one memory stored with code thereon, which when executed by said at least one processor, causes an apparatus to perform:
encoding a scalable bitstream comprising a base layer and at least one enhancement layer;
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture; and
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

A method according to a fifth embodiment comprises a method for decoding a scalable bitstream comprising a base layer and at least one enhancement layer, the method comprising
decoding a base-layer picture;
decoding one or more enhancement layer sub-pictures for said base-layer picture, said one or more enhancement layer sub-pictures having a size smaller than the corresponding enhancement layer reconstructed picture;
and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to an embodiment, decoded enhancement layer sub-pictures are placed in reference frame buffer separately than the decoded enhancement layer pictures.

According to an embodiment, decoded enhancement layer pictures are not placed in reference frame buffer, but decoded enhancement layer sub-pictures are placed in the reference frame buffer.

According to an embodiment, if spatial scalability is used, then samples outside the enhancement layer sub-picture area are copied from an upsampled base-layer picture.

According to an embodiment, decoding said one or more enhancement layer sub-pictures utilizes information from the base layer.

According to an embodiment, the one or more enhancement layer sub-pictures is converted to the same format used in the samples outside the area of said decoded one or more enhancement layer sub-pictures copied from the decoded base layer picture to the reconstructed enhancement layer picture, and the converted enhancement layer picture is merged to form a single enhancement layer picture in a reference frame buffer.

An apparatus according to a sixth embodiment comprises:
a video decoder configured for decoding a scalable bitstream comprising a base layer and at least one enhancement layer, the video decoder being configured for
decoding a base-layer picture;
decoding one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to a seventh embodiment there is provided a computer readable storage medium stored with code thereon for use by an apparatus, which when executed by a processor, causes the apparatus to perform:
decoding a scalable bitstream comprising a base layer and at least one enhancement layer, the video decoder being configured for
decoding a base-layer picture;
decoding one or more enhancement layer sub-pictures for a given base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to an eighth embodiment there is provided at least one processor and at least one memory, said at least one memory stored with code thereon, which when executed by said at least one processor, causes an apparatus to perform:
decoding a scalable bitstream comprising a base layer and at least one enhancement layer, the video decoder being configured for
decoding a base-layer picture;
decoding one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

According to a ninth embodiment there is provided a video encoder configured for encoding a scalable bitstream comprising a base layer and at least one enhancement layer, wherein said video encoder is further configured for
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture; and
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

According to a tenth embodiment there is provided a video decoder configured for decoding a scalable bitstream comprising a base layer and at least one enhancement layer, the video decoder being configured for
decoding a base-layer picture;
decoding one or more enhancement layer sub-pictures for said base-layer picture, said one or more enhancement layer sub-pictures having a size smaller than the corresponding enhancement layer reconstructed picture; and
   reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

1. A method comprising:
encoding and reconstructing a base-layer picture;
encoding and reconstructing one or more enhancement layer sub-pictures for said base-layer picture, said one or more enhancement layer sub-pictures having a size smaller than a corresponding enhancement layer reconstructed picture;
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

2. The method according to claim 1, wherein
the enhancement layer sub-pictures contain enhancement information to the corresponding base layer picture, the enhancement information including at least one of the following:
increasing the fidelity of the chroma of said one or more enhancement layer sub-pictures with respect to the chroma of the corresponding base layer picture;
increasing the bit-depth of said one or more enhancement layer sub-pictures with respect to the bit-depth of the corresponding base layer picture;
increasing the quality of said one or more enhancement layer sub-pictures with respect to the quality of the corresponding base layer picture; or
increasing the spatial resolution of said one or more enhancement layer sub-pictures with respect to the spatial resolution of the corresponding base layer picture.

3. The method according to claim 1, further comprising:
encoding predictively said one or more enhancement layer sub-pictures with respect to the base-layer picture; and
restricting the prediction process, if the enhancement layer sub-picture is coded predictively with respect to base layer, so that only the pixels within the co-located area of base layer picture are usable.

4. The method according to claim 1, wherein
the size and the position of the enhancement layer sub-pictures is allowed to be spatially overlapping.

5. The method according to claim 1, further comprising:
converting the one or more enhancement layer sub-pictures to the same format used in the samples outside the area of said reconstructed one or more enhancement layer sub-pictures copied from the reconstructed base layer picture to the reconstructed enhancement layer picture, and
merging the converted enhancement-layer picture to form a single enhancement layer picture in a reference frame buffer.

6. An apparatus comprising:
a video encoder configured for encoding a scalable bitstream comprising a base layer and at least one enhancement layer, wherein said video encoder is further configured for
encoding and reconstructing a base-layer picture;
encoding and reconstructing one or more enhancement layer sub-pictures for said base-layer picture, said one or more enhancement layer sub-pictures having a size smaller than the corresponding enhancement layer reconstructed picture;
reconstructing an enhancement layer picture from said reconstructed one or more enhancement layer sub-pictures, wherein samples outside the area of said reconstructed one or more enhancement layer sub-pictures is copied from the reconstructed base layer picture to the reconstructed enhancement layer picture.

7. The apparatus according to claims 6, wherein
the enhancement layer sub-pictures contain enhancement information to the corresponding base layer picture, the enhancement information including at least one of the following:
increasing the fidelity of the chroma of said one or more enhancement layer sub-pictures with respect to the chroma of the corresponding base layer picture;
increasing the bit-depth of said one or more enhancement layer sub-pictures with respect to the bit-depth of the corresponding base layer picture;
increasing the quality of said one or more enhancement layer sub-pictures with respect to the quality of the corresponding base layer picture; or
increasing the spatial resolution of said one or more enhancement layer sub-pictures with respect to the spatial resolution of the corresponding base layer picture.

8. The apparatus according to claim 6, wherein said video encoder is further configured for
converting the one or more enhancement layer sub-pictures to the same format used in the samples outside the area of said reconstructed one or more enhancement layer sub-pictures copied from the reconstructed base layer picture to the reconstructed enhancement layer picture, and
merging the converted enhancement-layer picture to form a single enhancement layer picture in a reference frame buffer.

9. A method comprising:
decoding a base-layer picture from a scalable bitstream;
decoding, from said scalable bitstream, one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

10. The method according to claim 9, further comprising:
placing the decoded enhancement layer sub-pictures in reference frame buffer separately from the decoded enhancement layer pictures.

11. The method according to claim 9, further comprising:
placing the decoded enhancement layer sub-pictures, but not the decoded enhancement layer pictures, in the reference frame buffer.

12. The method according to claim 9, further comprising:
copying, in response to spatial scalability being used, samples outside the enhancement layer sub-picture area from an upsampled base-layer picture.

13. The method according to claim 9, further comprising:
utilizing information from the base layer in decoding said one or more enhancement layer sub-pictures.

14. The method according to claim 9, further comprising:
converting the one or more enhancement layer sub-pictures to the same format used in the samples outside the area of said decoded one or more enhancement layer sub-pictures copied from the decoded base layer picture to the reconstructed enhancement layer picture, and
merging the converted enhancement layer picture to form a single enhancement layer picture in a reference frame buffer.

15. An apparatus comprising:
a video decoder configured for decoding a scalable bitstream comprising a base layer and at least one enhancement layer, the video decoder being configured for
decoding a base-layer picture;
decoding one or more enhancement layer sub-pictures for said base-layer picture, said one or more enhancement layer sub-pictures having a size smaller than the corresponding enhancement layer reconstructed picture; and
reconstructing a decoded enhancement layer picture from said decoded one or more enhancement layer sub-pictures, wherein samples outside the area of said decoded one or more enhancement layer sub-pictures is copied from the decoded base layer picture to the reconstructed enhancement layer picture.

16. The apparatus according to claim 15, the video decoder being configured for
placing the decoded enhancement layer sub-pictures in reference frame buffer separately from the decoded enhancement layer pictures.

17. The apparatus according to claim 15, the video decoder being configured for
placing the decoded enhancement layer sub-pictures, but not the decoded enhancement layer pictures, in the reference frame buffer.

18. The apparatus according to claim 15, the video decoder being configured for
converting the one or more enhancement layer sub-pictures to the same format used in the samples outside the area of said decoded one or more enhancement layer sub-pictures copied from the decoded base layer picture to the reconstructed enhancement layer picture, and
merging the converted enhancement layer picture to form a single enhancement layer picture in a reference frame buffer.
